(19) United States
(12) Patent Application Publication
(10) Pub. No.: US 2007/0168667 A1
(43) Pub. Date: Jul. 19, 2007

(54) Method, authentication medium and device for securing access to a piece of equipment

(75) Inventor: David Naccache, Paris (FR)

Correspondence Address: BUCHANAN, INGERSOLL & ROONEY PC, POST OFFICE BOX 1404, ALEXANDRIA, VA, 22313-1404, US

(73) Assignee: Gemplus, Gemenos (FR)

(21) Appl. No.: 10/588,460

(22) PCT Filed: Feb. 18, 2005
(86) PCT No.: PCT/EP05/50729

§ 371 Date: Aug. 4, 2006

(30) Foreign Application Priority Data
Feb. 27, 2004 (FR) 0402006

(51) Int. Cl. H04L 9/00

(52) U.S. Cl. 713/176

(57) ABSTRACT

The invention relates to a device for securing access to a piece of equipment (EQP), comprising an authentication medium (CRD) which uses a reference datum and control means (CTRL) which can be used to verify the consistency between the reference datum and a biometric signature (SGN) obtained from a party requesting access. According to the invention, the reference datum comprises an encrypted version (CRYPT_SGN02) of an authentic biometric signature (SGN02) attributed to the party requesting access, and the aforementioned data consistency is verified by comprising (COMPAR) the biometric signature (SGN) obtained from a party requesting access to an authentic biometric signature (SGN02) resulting from decryption of the encrypted version (CRYPT SGN02) of said signature using a secret key (K).

The invention relates, in general terms, to biometric authentication techniques that aim to control access to sensitive information.

More specifically, the invention relates, according to a first aspect, to a method of securing access to a piece of equipment, said method comprising at least: one attribution operation consisting of supplying a reference datum to an authentication medium; an acquisition operation consisting of obtaining, for every access request formulated by a party requesting access to the equipment, a biometric signature of this party requesting access; and a verification step consisting of using the reference datum to verify the authenticity of the biometric signature obtained from the party requesting access.

The authentication of persons using biometric signatures, such as, for example, fingerprints or the iris patterns of the eye, intrinsically has very high selectivity, but also poses specific problems that are not an issue in authentication by means of a personal numerical code entered by the person requesting access to a protected piece of equipment.

In fact, in the typical case in which the protected equipment comprises a computer, authentication by code is easily implemented by hiding the authentic numerical code split up into fractions in the computer's memory, reconstructing it every time an access request is received, and comparing the reconstructed authentic code with the code entered by the party requesting access.

However, authentication using biometric signatures cannot be implemented in the same way, insofar as, in the latter case, it is only possible to check for similarities or dissimilarities between an authentic biometric signature and a biometric signature entered by a party requesting access.

This singularity of authentication using biometric signatures makes it necessary in the practice to memorise the authentic biometric signatures in plain form in the computer's hard drive, which means that a hacker that manages to access this drive only once can obtain information therefrom that enables him to access it again easily as many times as he wants by disconnecting the biometric sensor and entering the data directly in the target machine.

The main aim of the invention is to provide a solution for this problem.

For this purpose, the method of the invention, which otherwise conforms to the generic definition provided in the preamble above, is essentially characterised in that it comprises a prior encryption step, during which an encrypted version of at least one authentic biometric signature belonging to at least one person authorised to access the piece of equipment is created, in that the verification step comprises a decryption operation implemented in the authentication medium and consisting of decrypting, by means of a secret key, the encrypted version of an authentic biometric signature supplied to this authentication medium as a reference datum during the access request, and in that the verification step comprises a comparing operation implemented by secretly comparing the biometric signature obtained from the party requesting access during the access request with the authentic biometric signature that results from the decryption step.

An authentication medium for implementing this method can be, for example, in the form of an electronic card comprising at least one decryption module using a secret key, this medium also possibly comprising a comparison module as well as, possibly, an encryption module.

The invention also relates to a device for securing access to a piece of equipment, comprising: an authentication medium which is supplied with a reference datum; a sensor obtaining, during every access request formulated by a party requesting access to the equipment, a biometric signature of this party requesting access; and control means included in the authentication medium and selectively authorising the party requesting access to access the piece of equipment in accordance with the result of a verification of the authenticity of the biometric signature of the party requesting access, carried out using the reference datum, this device being characterised in that the control means comprise a decryption module and a comparison module, in that the reference datum supplied to the authentication medium consists of an encrypted version of an authentic biometric signature allegedly attributed to the party requesting access, in that the decryption module uses a secret key by means of which it secretly reconstructs, upon each access request, the authentic biometric signature from its encrypted version, and in that the comparison module secretly compares the biometric signature obtained from the party requesting access with the reconstructed authentic biometric signature, and supplies a comparison result that constitutes the result of the verification.

In addition to the authentication medium, which for example consists of a card, removable or not, equipped with a memory that cannot be read from outside where the secret code is stored, the device of the invention can also comprise one or several computers that make up at least a part of the equipment to which the access is secured.

In this case, the computer or one of the computers can contain in its memory a plurality of personal identification codes attributed to a corresponding plurality of persons authorised to access the equipment and associated with a corresponding plurality of encrypted authentic biometric signatures for these authorised persons, this computer then being able to deliver to the identification medium, when receiving an access request, the encrypted authentic biometric signature that corresponds to the identification code supplied by the party requesting access.

A single authentication medium can therefore provide several persons with secure access to the computer.

The device of the invention can include an encryption module that is able to deliver an encrypted version of an authentic biometric signature supplied in plain form by the sensor in response to an encryption command.

In the case of the secret key being a private key with a matching public key, the encryption module can advantageously be included in the computer and use the public key of the authentication medium.

Further characteristics and advantages of the invention will appear clearly from the following description, provided as an example in a non-exhaustive manner, made in reference to the appended diagrams, in which:

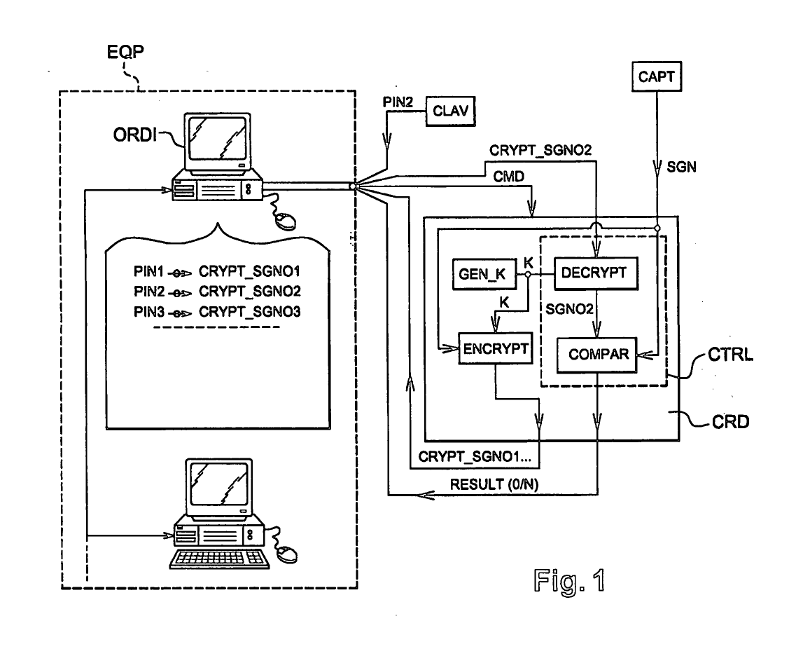

FIG. 1 is a diagram showing a first possible embodiment of the invention; and

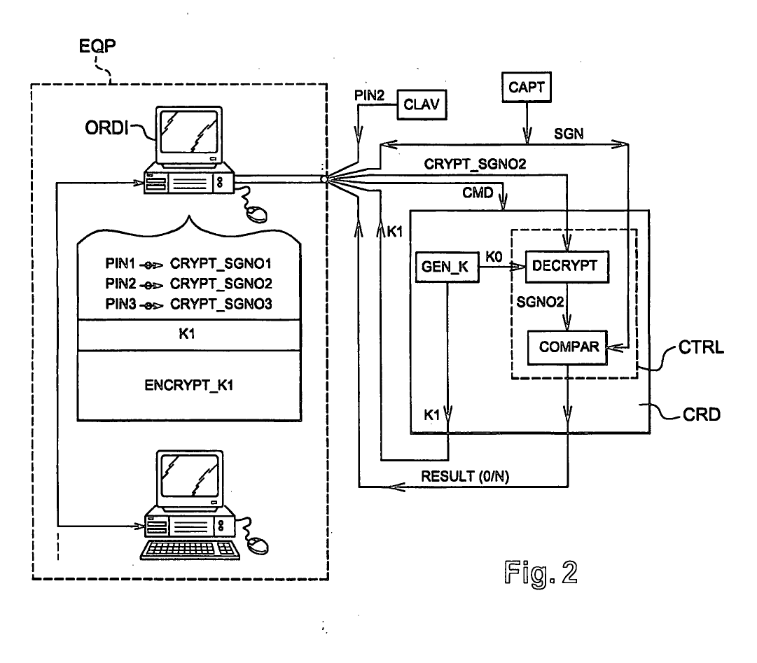

FIG. 2 is a diagram showing a second possible embodiment of the invention.

In these figures, the piece of equipment EQP to which access is secured is shown to include a computer ORDI, and this computer in turn is schematically shown to be connected to a keyboard CLAV, a sensor CAPT and an authentication medium CRD, the operation of which it can partially control by means of a command CMD, those skilled in the art being able to implement all the known specific means, in particular card readers, for creating the shown functional interactions and links.

As mentioned previously, the invention makes it possible to secure access to a piece of equipment EQP by means of biometric authentication of the persons requesting access to this piece of equipment.

For this purpose, the invention uses, in a manner known per se, an authentication medium CRD that is preferably in the form of an electronic chip card, equipped with a memory that cannot be read from outside.

Upon each request for access formulated by a party requesting access to the equipment EQP, a biometric signature SGN of the party requesting access, for example a fingerprint, is detected by the sensor CAPT and sent to the authentication medium CRD.

This authentication medium CRD then verifies the authenticity of the biometric signature SGN obtained from the party requesting access, by means of the control means CTRL with which it is equipped and using an encoded reference datum stored in EQP or ORDI and which is supplied to it by EQP or ORDI, and delivers a comparison result RESULT, which grants or declines an authorisation to access the piece of equipment EQP.

According to the invention, the reference datum used in each access request by the authentication medium CRD consists of an encrypted version, such as, for example, CRYPT_SGN02, of an authentic biometric signature, such as, for example, SGN02, belonging to a person authorised to access the equipment.

The method of the invention therefore comprises a prior step of registering the persons authorised to access the piece of equipment EQP, during which the encrypted versions CRYPT_SGN01, CRYPT_SGN02, CRYPT_{—SGN03 of the authentic biometric signatures SGN01, SGN02, SGN03 of these different persons are created.}

In the embodiment of the invention shown in FIG. 1, this prior encryption is carried out in the card CRD, when it receives a suitable command signal CMD, by an encryption module ENCRYPT using a secret key K supplied by an internal key generator GEN_K of the card CRD, this encryption being carried out on the authentic biometric signatures SGN01, SGN02, SGN03 received from the sensor CAPT and belonging to persons who are physically identified as being authorised to access this equipment.

The encrypted versions CRYPT_SGN01, CRYPT_SGN02, CRYPT_SGN03 of the various authentic biometric signatures SGN01, SGN02, SGN03 are then sent by the card CRD, upon receiving a suitable command signal CMD, to the hard drive of the computer ORDI where they are stored.

The encryption system used is then, for example, compliant with the advanced encryption standard that is known to those skilled in the art by the acronym AES (Advanced Encryption Standard).

The control means CTRL provided in the card CRD comprise a decryption module DECRYPT and a comparison module COMPAR.

Therefore, in order to authenticate a biometric signature SGN submitted by a party requesting access, the card CRD operates in two stages.

First of all, the decryption module DECRYPT of this card decrypts, by means of the internal secret key K of the card CRD, the encrypted version CRYPT_SGN02 of the authentic biometric signature SGN02 which is assumed to be that of the party requesting access, and which the computer ORDI supplies to the card CRD as a reference datum during the access request.

Then, the comparison module COMPAR of the card CRD secretly compares the biometric signature SGN, obtained from the party requesting access by means of the sensor CAPT during the access request, with the authentic biometric signature SGN02 reconstructed by the decryption module from its encrypted version CRYP_SGNO2.

Finally, the comparison module COMPAR supplies the computer ORDIN with a comparison result RESULT, which is the result of the verification performed, and which contains, for information purposes only, an indication of whether the biometric signature SGN obtained from the party requesting access is authentic or not.

In the embodiment of the invention shown in FIG. 2, the internal key generator GEN_K of the card CRD supplies, on the one hand, a private key K0 as an internal secret key of the card and, on the other hand, a public key K1 that matches this private key K0 and which can be supplied to the outside world, in particular to the computer ORDI.

In this embodiment of the invention, the encrypted versions CRYPT_SGN01, CRYPT_SGN02, CRYPT_SGN03 are obtained by encrypting the various authentic biometric signatures SGN01, SGN02, SGN03 using the public key K1, and these authentic biometric signatures SGN01, SGN02, SGN03 are reconstructed in the card CRD from their encrypted versions CRYPT_SGN01, CRYPT_SGN02, CRYPT_SGN03 by means of decryption using the private key K0.

In these conditions, as shown in FIG. 2, the public key K1 can be stored in the auxiliary storage of the computer ORDI and the encryption module ENCRYPT_K1 can also be saved in this computer, the important characteristic being, as in the first embodiment of the invention, that the authentic biometric signatures SGN01, SGN02, SGN03 are not permanently stored in plain form in the computer ORDI.

In contrast with the standard technique, in which the authentication medium CRD contains the reference datum made up of a biometric signature in plain form, the invention provides for this medium to contain only a secret key, in other words, depersonalised information.

In these conditions, the invention makes it possible for the same authentication medium CRD to offer secure access to the computer ORDI for several persons.

The only constraint is that the biometric signature of each party requesting access must actually compare with an authentic biometric signature assumed a priori to be attributed to this party.

If a small number of persons are authorised to access the piece of equipment EQP, it is feasible for the computer ORDI to supply the card CRD with the encrypted versions CRYPT_SGN01, CRYPT_SGN02, CRYPT_SGN03 of the authentic biometric signatures SGN01, SGN02, SGN03 of all the persons authorised to access the piece of equipment every time it receives an access request, and for this access to be authorised whenever one of the decrypted authentic signatures matches the signature SGN obtained from the party requesting access.

If, on the contrary, the number of persons authorised to access the piece of equipment EQP is relatively high, it may be useful for each party requesting access to previously identify himself by means of a personal code, such as PIN1, PIN2, PIN3; however, this code does not need to be confidential, since it is only used by the party requesting access to select the encrypted version of the biometric signature previously called up during the access request, and not to grant the request.

Specifically, every person authorised to access the equipment EQP can be identified, during the prior registration step, by such a personal code PIN1, PIN2, PIN3, and the personal code of each person can be memorised in the computer ORDI, so as to be matched with the encrypted authentic biometric signature of this person.

During an access request, the party requesting access can identify himself in this way by entering a personal code on the keyboard CLAV, the computer ORDI then delivering the encrypted authentic biometric signature, for example CRYPT_SGN02, that corresponds to the identification code entered by the party requesting access, for example PIN2 to the identification medium CRD.

1. A method of securing access to a piece of equipment, comprising: one attribution operation supplying a reference datum to an authentication medium; an acquisition operation obtaining, for every access request formulated by a party requesting access to the equipment, a biometric signature of said party requesting access; and a verification step verifying, by means of the reference datum, the authenticity of the biometric signature obtained from the party requesting access, further including a prior encryption step, during which an encrypted version of at least one authentic biometric signature belonging to at least one person authorised to access the piece of equipment is created, wherein the verification step comprises a decryption operation implemented in the authentication medium which includes decrypting, by means of a secret key, the encrypted version of an authentic biometric signature supplied to said authentication medium as a reference datum during the access request, and wherein the verification step comprises a comparing operation implemented by secretly comparing the biometric signature obtained from the party requesting access during the acccess request with the authentic biometric signature that results from the decryption step.

2. An authentication medium for implementing the method according to claim 1, comprising an electronic card having at least one decryption module using a secret key.

3. An authentication medium according to claim 2, further comprising a comparison module.

4. An authentication medium according to claim 2 further comprising an encryption module.

5. A device for securing access to a piece of equipment, comprising: an authentication medium which is supplied with a reference datum; a sensor obtaining, during every access request formulated by a party requesting access to the equipment, a biometric signature of said party requesting access; and a controller included in the authentication medium and selectively authorising the party requesting access to access the piece of equipment in accordance with the result of a verification of the authenticity of the biometric signature of the party requesting access by means of the reference datum wherein the controller comprises a decryption module and a comparison module wherein the reference datum supplied to the authentication medium comprises an encrypted version of an authentic biometric signature allegedly attributed to the party requesting access, wherein the decryption module uses a secret key by means of which it secretly reconstructs, upon each access request, the authentic biometric signature from its encrypted version and wherein the comparison module secretly compares the biometric signature obtained from the party requesting access with the reconstructed authentic biometric signature and supplies a comparison result that constitutes the result of the verification.

6. A security device according to claim 5, wherein the authentication medium is a card, equipped with a memory that cannot be read from outside, in which the secret key is stored.

7. A security device according to claim 5, further comprising at least one computer that makes up at least a part of the equipment to which the access is secured.

8. A security device according to claim 7, wherein the computer contains in its memory a plurality of personal identification codes attributed to a corresponding plurality of persons authorised to access the equipment and associated with a corresponding plurality of encrypted authentic biometric signatures for these authorised persons, and wherein the computer delivers to the identification medium when receiving an access request, the encrypted authentic biometric signature that corresponds to the identification code supplied by the party requesting access, such that a single authentication medium provides several persons with secure access to the computer.

9. A security device according to claim 5, further comprising an encryption module delivers an encrypted version of an authentic biometric signature supplied in plain form by the sensor in response to an encryption command.

10. A security device according to claim 9, wherein the secret key is a private key with a matching public key and wherein the encryption module is included in the computer and uses the public key.

11. An authentication medium according to claim 3 further comprising an encryption module.

12. A security device according to claim 6, further comprising at least one computer that makes up at least a part of the equipment to which the access is secured.

13. A security device according to claim 6, further comprising an encryption module that delivers an encrypted version of an authentic biometric signature supplied in plain form by the sensor in response to an encryption command.

14. A security device according to claim 7, further comprising an encryption module that delivers an encrypted version of an authentic biometric signature supplied in plain form by the sensor in response to an encryption command.

15. A security device according to claim 8, further comprising an encryption module that delivers an encrypted version of an authentic biometric signature supplied in plain form by the sensor in response to an encryption command.
